(19) United States
(12) Patent Application Publication
(10) Pub. No.: US 2005/0111486 A1
(43) Pub. Date: May 26, 2005

(54) Device and method for controlling network devices located within private networks

(75) Inventors: Won-hee Lee, Seongnam-si (KR); Young-chul Sohn, Suwon-si (KR); Jung-yon Cho, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/986,045

(22) Filed: Nov. 12, 2004

(30) Foreign Application Priority Data
Nov. 26, 2003 (KR) 10-2003-0084624

(51) Int. Cl. H04J 3/16

(52) U.S. Cl. 370/465

(57) ABSTRACT

A network connection device is provided, having a request message processor which processes an information request message transmitted from a first private network; a message parsing/address converting manager which parses an acknowledgement message which at least one second network device within a second private network prepares, and which converts a private Internet protocol address of the second network device into a public Internet protocol address; and a controller which transmits the message which the request message processor processes to the second network device, and which transmits the acknowledgement message which the second network device prepares to the message parsing/address converting manager. Further, a control device located on one private network sets a permanent communication channel with another external private network to obtain information generated asynchronously from controlled devices located on the other external private network, which is used to transmit the information generated asynchronously.

### CROSS-REFERENCE TO RELATED APPLICATION

This application is based on and claims priority from Korean Patent Application Nos. 10-2003-0084624 filed with the Korean Intellectual Property Office on Nov. 26, 2003, the disclosure of which is hereby incorporated herein by reference in its entirety.

### BACKGROUND OF THE INVENTION

1. Field of the Invention

The present invention generally relates to a system and method for controlling network devices located within private networks. More particularly, the present invention relates to a system and method for controlling network devices located within private networks, so as to provide remote control for the network devices located within external private networks.

2. Discussion of Related Art

Home networks are generally constructed with an Internet protocol (IP) based private network, and governs various devices and apparatuses, such as different types of personal computers (PCs), intelligent appliances and wireless devices, which are used at home, over a single network, through a common virtual computing environment called “middleware.”

A home network middleware standard, Universal Plug and Play (UPnP), enables interaction between various home network devices. Such a home network is composed of at least one UPnP controlled device which provides available functions, and a control point which controls operation of the UPnP controlled device and which makes use of functions provided by the UPnP controlled device.

In order to provide functions that a user requires for practicality, the UPnP control point discovers any UPnP controlled device, sends commands to the discovered UPnP controlled device, and presents information sent from the UPnP controlled device to the user. When a user desires to use the UPnP control point not only on one home network, to which the UPnP control point belongs, but also on an external home network, to which the UPnP control point does not belong, but the UPnP control point does not have a public IP address but rather a private IP address on the other external home network, the UPnP controlled device on the one home network cannot obtain positive access and send information to the UPnP control point on the other external home network. Further, because of this restriction, access to receive information on services that the UPnP controlled device on the home network provides is not available at the other external home network.

Such restriction results not only from the private network which is configured not to use the IP address for public use but to use an address space (e.g., RFC1918) designed to be available only within a specific group because of a limited capacity of the IP address, but also from a rule defined not to access the public network using the private IP address.

Meanwhile, only a gateway can permit access to the public network using the private IP address within the private network. However, even in such a case, devices having private IP addresses are allowed to access devices having the public IP addresses, but not vice versa.

FIG. 1 is a schematic block diagram showing a conventional UPnP network system. The UPnP network system includes a UPnP control point (CP) 11, a UPnP controlled device (CD) proxy 12, a UPnP CP proxy 13 and one or more UPnP CDs 14.

The UPnP CP 11 controls the UPnP CDs 14 located within an external private network. Thereby, the UPnP CDs 14 are controlled by the UPnP CP 11 and provide desired information to the UPnP CP 11.

The UPnP CD proxy 12 receives a multicast packet which the UPnP CDs 14 generate, from the UPnP CP proxy 13, and transmits the packet to the UPnP CP 11 in a multicast mode whereby it is possible for the UPnP CP 11 to locate the UPnP CDs on the external private network.

The UPnP CP proxy 13 receives the multicast packet, which the external UPnP CP 11 generates in order to discover the UPnP CDs 14, from the UPnP CD proxy 12, and multicasts the packet to the UPnP CDs 14 again. Subsequently, the UPnP CP proxy 13 receives an acknowledgement packet relative to the multicast packet from the UPnP CDs 14, and transmits the received packet to the UPnP CD proxy 12 again whereby it is possible for the UPnP CP 11 to locate a desired one among the UPnP CDs.

In order to locate and control the UPnP CDs at a remote site, the UPnP CP 11 located at the remote site finds a uniform resource locator (URL) corresponding to a UPnP CD 14, and accesses the UPnP CD 14 based on the found URL. Here, assuming that the UPnP CD 14 always uses the public IP address (unique and proper over the Internet), the UPnP CP 11 is capable of accessing the UPnP CD through the URL thereof and other URLs such as a control URL, or a presentation URL, etc. which may be obtained through the URL. In other words, both of the UPnP CP 11 and UPnP CD 14 make use of the public IP address, thus allowing direct communication to be performed without any assistance from other devices. As a result, it is possible to perform all controls which are permissible at the UPnP.

However, under the assumption that the UPnP CP 11 and the UPnP CD proxy 12 are located on a first private network and that the UPnP CDs 14 are located on a second private network, the following problems may occur:

When the UPnP CP proxy 13 attempts to transmit information generated from the UPnP CDs 14 to the UPNP CD proxy 12, it may be impossible to access the UPnP CD proxy 12 for which it belongs to the first private network, and thus it may be also impossible to transmit the information thereto. Further, when any attempt is made to use services through universal resource identifiers (URIs) which the UPnP CDs 14 provide, and when information on addresses denoted at the URIs are matched to the private IP addresses belonging to the second private network, it may also be impossible to access the services.

U.S. Patent Application Publication No. 2003-126239, titled MOBILE COMMUNICATION TERMINAL, NETWORK ACCESS SYSTEM AND METHOD THEREOF USING THE SAME, discloses a system comprising a mobile communication terminal having a network conversion module for mutual-converting a local IP of a UPnP device into a global IP in order to access an external network. However, this system has a problem in that it cannot be operated under the UPnP home network environment because it is used for a service converting the IP address in the wireless communication.

### SUMMARY OF THE INVENTION

To solve the above-indicated problems, it is, therefore, an objective of the present invention to provide an environment under which a message between the network devices is parsed, and private IP addresses of the network devices are converted into public IP addresses, thereby it is possible to make use of services which the network devices provide on the private networks without any correction, beyond a simple discovery of the network devices.

It is another objective of the present invention to provide setting of a permanent communication channel in order to transmit asynchronous information generated from a controlled device to a control device located within a private network.

Consistent with an exemplary embodiment of the invention, there is provided a device for controlling network devices located on private networks. The device comprises a transceiving section which transmits an information request message to at least one network device located within one external private network, and receives an acknowledgement message which the at least one network device located within the one external private network transmits. Further, the device comprises a communication channel connecting section which connects between the network device located within the one external private network and another private network through at least one communication channel set by a public Internet protocol (IP) address.

According to another exemplary embodiment of the invention, a network connection device comprises a request message processor which processes an information request message transmitted from a first private network, a message parsing/address converting manager which parses an acknowledgement message which at least one second network device within a second private network drafts, and which converts a private Internet protocol address of the second network device into a public Internet protocol address, and a controller which transmits the message which the request message processor processes to the second network device, and which transmits the acknowledgement message which the second network device drafts to the message parsing/address converting manager.

According to yet another exemplary embodiment of the invention, there is provided a method for controlling network devices located on private networks. The method comprises the steps of: a) transmitting an information request message from a first network device to a second network device; b) converting a private Internet protocol address of the first network device into a public Internet protocol address, and transmitting the information request message to the second network device; and c) receiving an acknowledgement message which the second network device transmits.

According to yet still another exemplary embodiment of the invention, there is provided a method for controlling network devices located on private networks, the method comprising the steps of: a) parsing an information request message received from a first network device and transmitting the parsed information request message to a second network device; b) drafting an acknowledgement message at the second network device receiving the information request message and transmitting the drafted acknowledgement message to the first network device; and c) parsing the acknowledgement message to convert a private Internet protocol address of the second network device which is encapsulated in the acknowledgement message into a public Internet protocol address, and transmitting the acknowledgement message to the first network device.

According to yet still another exemplary embodiment of the invention, there is provided a method for controlling network devices located on private networks, the method comprising the steps of: a) at a first network device, requesting to connect a communication channel with a second network device; b) converting a private Internet protocol address of the first network device into a public Internet protocol address of a gateway, and requesting to connect the communication channel to a network connection device; and c) generating the communication channel between the public Internet protocol address of the gateway and a public Internet protocol address of the network connection device.

### BRIEF DESCRIPTION OF THE DRAWINGS

The above objects, features and advantages of the present invention will become more apparent from the following detailed description and accompanying drawings, which should not be read to limit the invention in any way, in which:

FIG. 1 is a schematic block diagram showing a conventional UPnP network system;

FIG. 2 is a schematic block diagram illustrating a device for controlling network devices located on private networks in accordance with an exemplary embodiment of the present invention;

FIG. 3 is a schematic block diagram illustrating an internal system for controlling network devices located on private networks in accordance with an exemplary embodiment of the present invention;

FIG. 4 is a schematic flow chart showing a method for controlling network devices located on private networks in accordance with an exemplary embodiment of the present invention;

FIG. 5 is a schematic flow chart showing a method for controlling network devices located on private networks in accordance with an exemplary embodiment of the present invention, particularly, by means of a permanent communication channel; and

FIGS. 6A, 6B, and 6C show a method for controlling network devices located on private networks in accordance with an exemplary embodiment of the present invention.

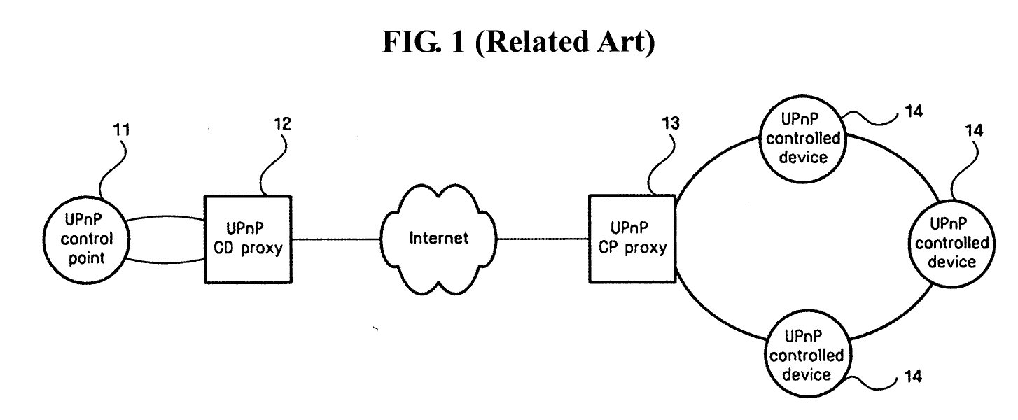

### DETAILED DESCRIPTION OF THE EXEMPLARY EMBODIMENTS

Exemplary embodiments of the present invention will be described below in detail with reference to the accompanying drawings.

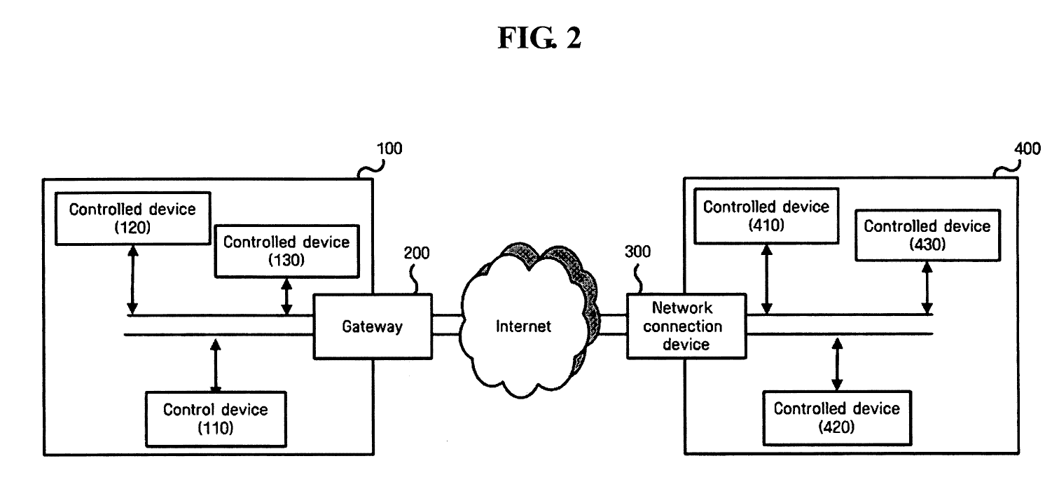

FIG. 2 is a schematic block diagram illustrating a device for controlling network devices located on private networks in accordance with an exemplary embodiment of the present invention. The device includes a first private network 100, a gateway 200, a network connection device 300, and a second private network 400.

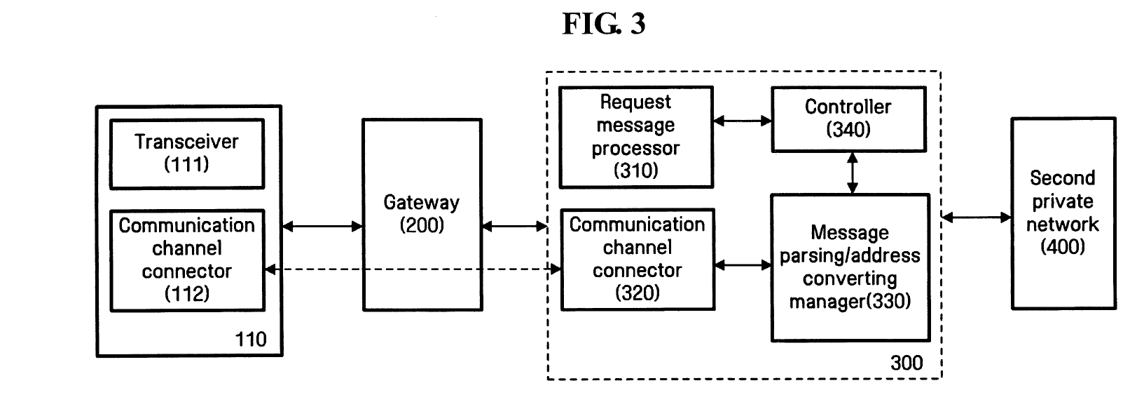

The first private network 100 is composed of a control device 110 and one or more controlled devices 120 and 130. Here, the control device 110 transmits an information request message in order to control one or more specific controlled devices within the external private network. As shown in FIG. 3, the control device 110 includes a transceiver 111 and a communication channel connector 112. Further, the control device 110 and the controlled devices 120 and 130 each have a private Internet protocol (IP) address. The control device 110 possesses information of the controlled devices within an external private network through processes of discovery and description.

The gateway 200 converts the private IP address of the control device 110 into a public IP address with which accessing the external private network is available when the control device 110 of the first private network attempts to access the external private network. The gateway 200 has a mapping table for storing the private and public IP addresses of the control device 110 when the private IP address of the control device 110 located within the first private network 100 is converted into the public IP address. Then, when a predetermined message is transmitted from the external private network, the gateway 200 transmits the predetermined message to the private IP address of at least one specific device which is mapped to the public IP address with reference to the mapping table.

The network connection device 300 receives the information request message transmitted from the first private network 100, processes the received information request message, and transmits the processed information request message to at least one corresponding network device (i.e., controlled device). Further, the network connection device 300 parses an acknowledgement message received from the network device (i.e., controlled device), and converts the private IP address of the network device into the public IP address with which accessing to the external private network is available. The network connection device 300 includes a request message processor 310, a communication channel manager 320, a message parsing/address converting manager 330 and a controller 340.

The second private network 400 is comprised of one or more controlled devices 410, 420 and 430, and receives the information request message transmitted from the external private network, and prepares and transmits an acknowledgement message for the received information request message. The controlled devices 410, 420 and 430 each have a private IP address.

Further, the gateway 200 is connected to the first private network 100, comprising the control device 110 and the controlled devices 120 and 130, while the network connection device 300 is connected to the second private network 400, comprising the controlled devices 410, 420, and 430. The control device 110 and the controlled devices 120, 130, and the controlled devices 410, 420 and 430, which are located in the first and second private networks, respectively, are connected with an external Internet or a public network via the gateway 200 and network connection device 300.

FIG. 3 is a schematic block diagram illustrating an internal system for controlling network devices located on private networks in accordance with an exemplary embodiment of the present invention.

The transceiver 111 transmits the information request message to one or more network devices (i.e., controlled devices) which are located on the external second private network 400, and receives the acknowledgement messages which the controlled devices located on the external second private network 400 transmit.

The communication channel connector 112 interconnects the first private network 100 and the external second private network 400 by means of a transmission control protocol (TCP) communication channel, which is generated between the public IP address of the gateway 200 and the public IP address of the network connection device 300. Here, the TCP communication channel allows the first and second private networks to be permanently connected by periodically transceiving live data. As a result, the control device 110 of the first private network 100 continues to transmit and receive the data to and from the controlled devices of the second private network 400.

The request message processor 310 is for processing the information request message transmitted from the first private network 100. Specifically, when the information request message is received from the first private network 100, the request message processor 310 parses the received message to check from which network device the first private network 100 requests information, and transmits the received message to the corresponding network device according to the checking result.

The message parsing/address converting manager 330 is for parsing the acknowledgement messages prepared by the network devices (i.e., controlled devices) located on the second private network 400 and converting the private IP addresses of the controlled devices into public IP addresses. Specifically, when the controlled devices prepare and transmit the acknowledgement messages for information which the control device 110 within the first private network 100 requests, the message parsing/address converting manager 330 parses the prepared acknowledgement messages to convert the private IP addresses of the controlled devices into public IP addresses, and transmits the converted public IP addresses. Here, the message parsing/address converting manager 330 generates the mapping table for storing the private and converted public IP addresses of the controlled devices located within the second private network 400.

The controller 340 transmits the message which the request message processor 310 has processed to one or more corresponding controlled devices of the second private network 400, and transmits the acknowledgement messages which the controlled devices prepare to the message parsing/address converting manager 330.

The communication channel manager 320 is for transmitting the data or messages using the TCP communication channel which is generated between the public IP address of the gateway 200 and the public IP address of the network connection device 300. Here, the TCP communication channel is permanently connected between the first and second private networks 100 and 400, so that the private networks can continue to transmit and receive the data

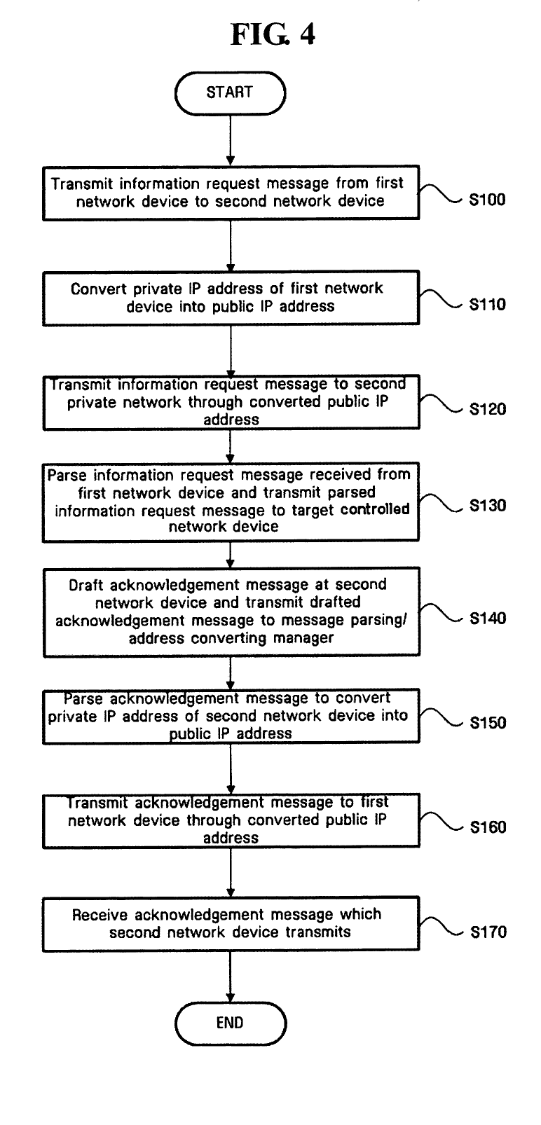

FIG. 4 is a schematic flow chart showing a method for controlling network devices located on private networks in accordance with an exemplary embodiment of the present invention. First, when the control device 110 within the first private network 100 transmits an information request message to a specific controlled device, for example the controlled device 430, within the second private network 400 (S100), the gateway 200 converts the private IP address (e.g., 192.168.1.100) of the control device 110 into the public IP address (e.g., 1.1.1.1) of the gateway 200 with which accessing the external private network is available, and then transmits the acknowledgement message for the information request message to the network connection device 300 (S110 and S120). The gateway 200 stores both the private IP address of the control device 110 and the public IP address of the gateway 200 in the mapping table (see Table 1 below)

TABLE 1

| Private IP address | Port | Public IP address | Port |
|---|---|---|---|
| 192.168.1.100 | 9864 | 1.1.1.1 | 10956 |

Then, the request message processor 310 receives the information request message transmitted from the first private network 100, and parses the received information request message to find from which controlled device the first private network 100 requests information.

The received information request message and the information of the corresponding controlled device (e.g., the controlled device 430) are transmitted to the controller 340. The controller 340 transmits the information request message to the corresponding controlled device 430 (S130).

Subsequently, the controlled device 430 receiving the information request message prepares an acknowledgement message for the information request message and transmits the prepared acknowledgement message to the controller 340. The controller 340 having received the acknowledgement message from the controlled device 430 transmits the acknowledgement message to the message parsing/address converting manager 330 (S140).

Accordingly, the message parsing/address converting manager 330 parses the received acknowledgement message, and converts the private IP address (e.g., 10.1.1.100) of the controlled device 430, which is embedded in the acknowledgement message, into the public IP address (e.g., 2.2.2.1) of the network connection device 300 (S150). Both the private IP address of the controlled device 430 and the converted public IP address of the network connection device 300 are stored in the mapping table (see Table 2 below).

TABLE 2

| Public IP address | Port | Private IP address | Port |
|---|---|---|---|
| 2.2.2.1 | 20988 | 10.1.1.100 | 80 |

Then, the message parsing/address converting manager 330 transmits the acknowledgement message, which the controlled device 430 has prepared, to the control device 110 within the first private network 100 through the converted public IP address (S160).

Subsequently, after receiving the acknowledgement message, the gateway 200 searches for a private IP address corresponding to the received public IP address in the mapping table, and transmits the acknowledgement message to the control device 110 corresponding to the searched private IP address (S170). For example, when the acknowledgement message is transmitted to 1.1.1.1:10956, i.e., the public IP address of the gateway 200, the gateway 200 transmits the received acknowledgement message to 192.168.1.100:9864, i.e., the private IP address of the control device 110 and is mapped to the public IP address (i.e., 1.1.1.1:10956).

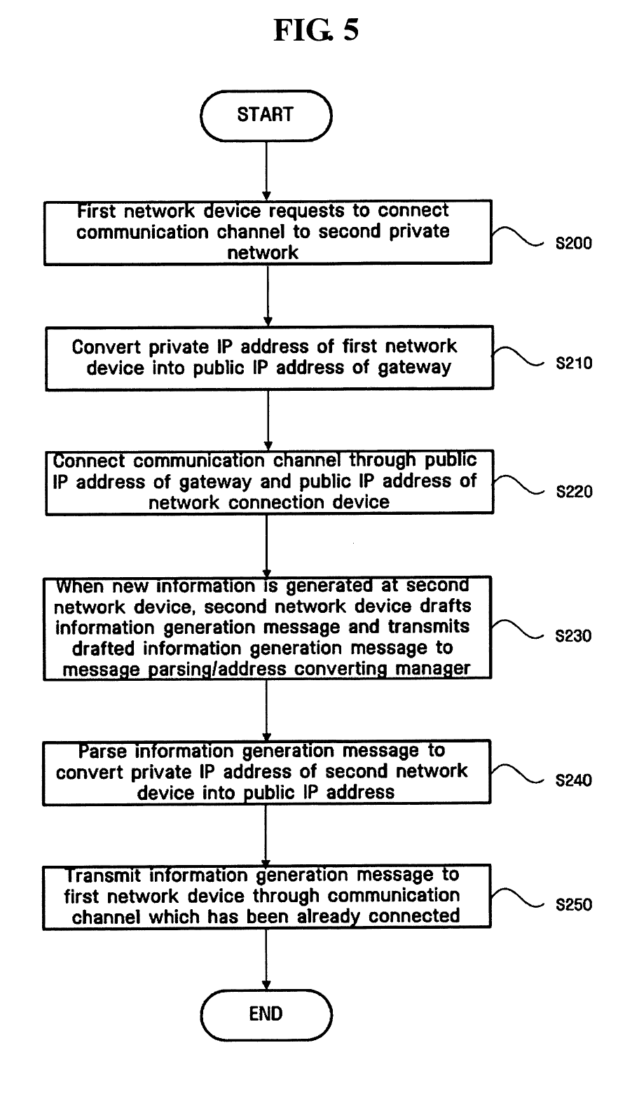

FIG. 5 is a schematic flow chart showing a method for controlling network devices located on private networks in accordance with an exemplary embodiment of the present invention, particularly, by means of a permanent communication channel.

To begin with, when the control device 110 transmits a message of requesting to connect the communication channel with the second private network 400 (S200), the gateway 200 converts the private IP address (e.g., 192.168.1.100) of the control device 110 into the public IP address (e.g., 1.1.1.1) (S210), and then stores both the private IP address of the control device 110 and the converted public IP address of the gateway 200 in the mapping table (see Table 1 above).

Then, the gateway 200 has access to the network connection device 300 through the public IP address. In other words, the TCP communication channel is generated between the public IP address of the gateway 200 and the public IP address (e.g., 2.2.2.1) of the network connection device 300 (S220). In order to steadily maintain the TCP communication channel generated between the gateway 200 and the network connection device 300, predetermined data (e.g., the live data) is continuously transmitted. Thereby, the control device 110 within the first private network 100 is capable of continuing to transmit and receive data to and from one or more controlled devices within the second private network 400.

Subsequently, when new information is generated from the second network device (e.g., the controlled device 410), the controlled device 410 prepares an information generation message and transmits the prepared information generation message to the controller 340. Then, the controller 340 transmits the received information generation message to the message parsing/address converting manager 330 (S230).

The message parsing/address converting manager 330 parses the received information generation message to convert the private IP address (e.g., 10.1.1.100) of the controlled device 410 which is embedded in the information generation message into the public IP address (e.g., 2.2.2.1) (S240), and then stores both the private IP address of the controlled device 410 and the converted public IP address of the network connection device 300 in the mapping table (see Table 2 above).

Next, the message parsing/address converting manager 330 transmits the information generation message to the communication channel manager 320, and the communication channel manager 320 transmits the received information generation message through the communication channel which has been already set (S250). Specifically, the communication channel manager 320 transmits the information generation message which the controlled device 410 has prepared to the gateway 200 through the communication channel. Thus, the gateway 200 transmits the received information generation message to 192.168.1.100:9864 which is the private address of the control device 110 and is stored in the mapping table. Thereby, the control device 110 and the controlled device 410 can continue transmitting and receiving data through the communication channel.

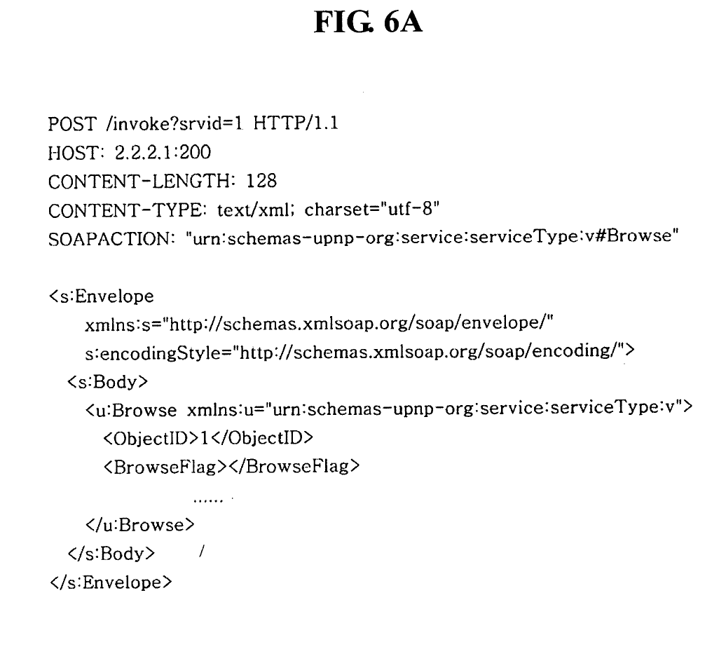

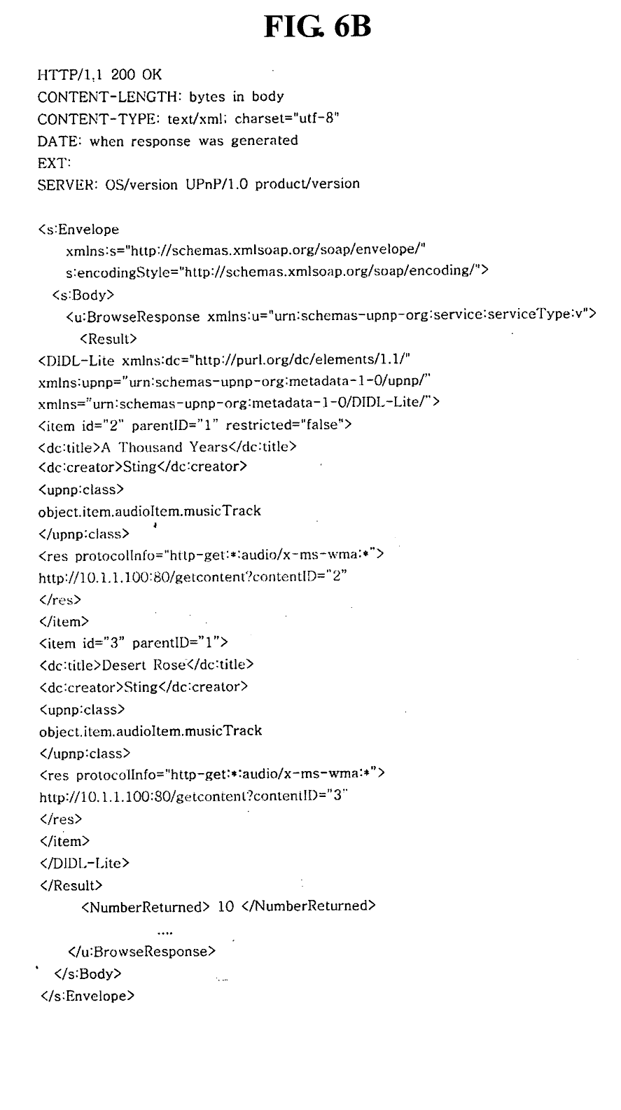

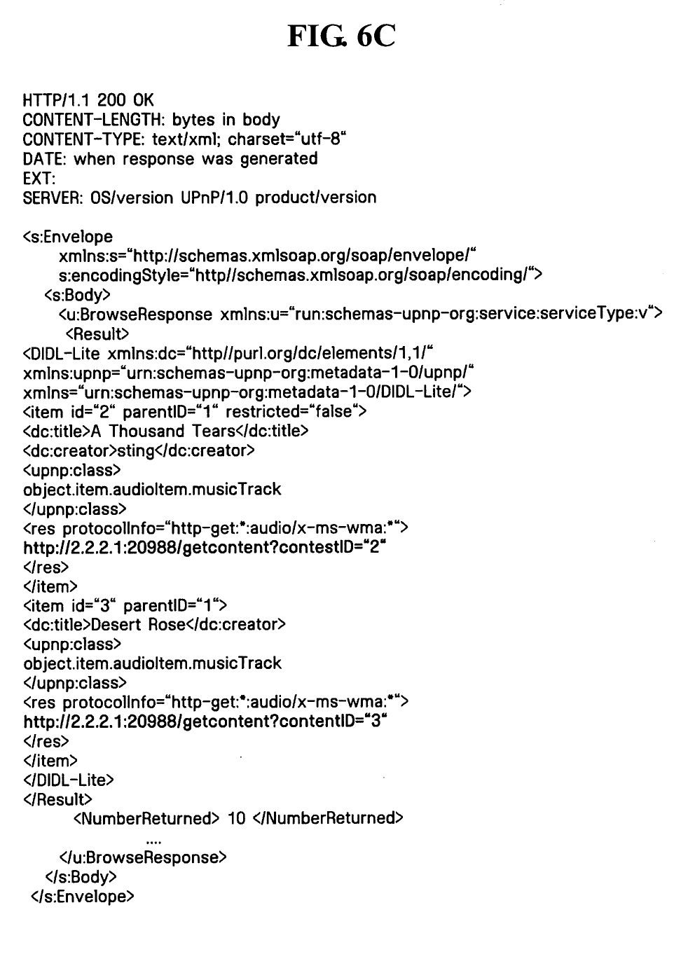

FIGS. 6A, 6B, and 6C show a method for controlling network devices located on private networks in accordance with one exemplary embodiment of the present invention.

First, when the control device 110 of the first private network 100 transmits an information request message to the controlled device 410 of the second private network 400, the gateway 200 converts the private IP address (e.g., 192.168.1.100) of the control device 110 into the public IP address (e.g., 1.1.1.1) of the gateway 200, and connects the control device 110 with the network connection device 300. Here, the gateway 200 generates the mapping table which both the private IP address of the control device 110 and the public IP address of the gateway 200 are stored (see Table 1 above).

Then, the network connection device 300 parses the information request message which the control device 110 has transmitted. For example, as shown in FIG. 6A, the network connection device 300 parses the part of “POST/invoke?svrid=1 HTTP/1.1” to discover the controlled device which must directly receive the request message which the control device 110 has transmitted.

Therefore, the network connection device 300 parses the information request message to be transmitted to the controlled device (which is herein assumed to be controlled device 410) having an identifier (ID) of svrid=1, and transmits the received information request message to the corresponding controlled device 410.

Next, the controlled device 410 prepares the acknowledgement message for the information request message which the control device 110 has transmitted, and transmits the prepared acknowledgement message to the network connection device 300. As shown at lines 23 and 33 of FIG. 6B, the private IP address (e.g., 10.1.1.100:80) of the controlled device 410 is contained in the acknowledgement message.

Accordingly, the network connection device 300 parses the received acknowledgement message, and then converts the private IP address (e.g., 10.1.1.100:80) of the controlled device 410, which is embedded in the acknowledgement message which the controlled device 410 has prepared, into the public IP address (e.g., 2.2.2.1:20988) of the network connection device 300 (see lines 23 and 33 of FIG. 6C).

Then, the network connection device 300 stores both the private IP address of the controlled device 410 and the converted public IP address of the network connection device 300 in the mapping table (see Table 2 above).

The network connection device 300 transmits the acknowledgement message to the IP address of the first private network 100 which has transmitted the information request message (here, the network connection device 300 knows the public IP address of the gateway 200).

Therefore, when the acknowledgement message is received from the public IP address (e.g., 1.1.1.1:10956) of the gateway 200, the gateway 200 transmits the received acknowledgement message to the private address (e.g., 192.168.1.100:9864) which is mapped to the public IP address (i.e., 1.1.1.1:10956) using the mapping table.

While the present invention has been illustrated and described with reference to exemplary embodiments thereof, it will be understood by those skilled in the art that various changes in form and details may be made therein without departing from the spirit and scope of the invention as defined by the appended claims.

According to the exemplary embodiment of the present invention configured as mentioned above, in order to provide remote control for at least one controlled device located within the second private network, the control device located within the first private network establishes the permanent communication channel which is set by the public IP address with the network connection device for connecting the external private network, so that the control device can be connected with the controlled device to control the controlled device.

Further, by setting the permanent communication channel, asynchronous information generated from the controlled device can be transmitted to the control device located on the first private network.

Furthermore, the network connection device parses the message transmitted/received between the network devices (control device and controlled device) to transmit the parsed message to the corresponding network device, so that it is possible to provide a simple control of the network devices as well as a streaming service of video/audio files.

In addition, by providing a network address translation (NAT) environment of converting the URL consisting of the private IP address of the network device into the URL consisting of the public IP address, it is possible not only to control the network devices located on the external private networks but also to make use of services which the network devices provide on the private networks without any correction.

1. A device for controlling network devices located on private networks comprising:
a transceiving unit which transmits an information request message to at least one network device located within an external private network, and which receives an acknowledgement message which the at least one network device located within the one external private network transmits; and
a communication channel connecting unit which interconnects the network device located within the external private network and another private network through at least one communication channel set by a public Internet protocol (IP) address.

2. The device as claimed in claim 1, wherein the communication channel is permanently connected by periodically transceiving live data.

3. A network connection device comprising:
a request message processor which processes an information request message transmitted from a first private network;
a message parsing and address converting manager which parses an acknowledgement, message which at least one second network device within a second private network prepares, and converts a private Internet protocol address of the second network device into a public Internet protocol address; and
a controller which transmits the message which the request message processor processes to the second network device, and transmits the acknowledgement message which the second network device prepares, to the message parsing and address converting manager.

4. The network connection device as claimed in claim 3, wherein the message parsing and address converting manager includes a mapping table for storing the private Internet protocol address of the second network device and the public Internet protocol address.

5. The network connection device as claimed in claim 3, further comprising a communication channel manager which transmits a message of the second private network to the first private network through the communication channel set and connected by the public Internet protocol address.

6. The network connection device as claimed in claim 5, wherein the communication channel is permanently connected by periodically transceiving live data.

7. A method for controlling network devices located on private networks, the method comprising:
a) transmitting an information request message from a first network device to a second network device;
b) converting a private Internet protocol address of the first network device into a public Internet protocol address, and transmitting the information request message to the second network device; and
c) receiving an acknowledgement message which the second network device transmits.

8. The method as claimed in claim 7, wherein step b) further comprises storing the private Internet protocol address of the first network device and the converted public Internet protocol address in a mapping table.

9. A method for controlling network devices located on private networks, the method comprising:
a) parsing an information request message received from a first network device and transmitting the information request message to a second network device;
b) preparing an acknowledgement message at the second network device and transmitting the acknowledgement message to the first network device; and
c) parsing the acknowledgement message to convert a private Internet protocol address of the second network device which is embedded in the acknowledgement message into a public Internet protocol address, and transmitting the acknowledgement message to the first network device.

10. The method as claimed in claim 9, further comprising storing the private Internet protocol address of the second network device and the converted public Internet protocol address in a mapping table.

11. A method for controlling network devices located on private networks, the method comprising:
a) at a first network device, requesting to connect a communication channel to a second network device;
b) converting a private Internet protocol address of the first network device into a public Internet protocol address of a gateway, and requesting to connect the communication channel to a network connection device; and
c) generating the communication channel between the public Internet protocol address of the gateway and a public Internet protocol address of the network connection device.

12. The method as claimed in claim 11, wherein the communication channel is permanently connected by periodically transceiving live data.

13. The method as claimed in claim 11, further comprising:
d) when new information is generated from the second network device, preparing an information generation message at the second network device and transmitting the information generation message to the first network device;
e) parsing the information generation message to convert a private Internet protocol address of the second network device which is embedded in the information generation message into a public Internet protocol address; and
f) transmitting the information generation message to the first network device using the communication channel which has been already connected.

14. The method as claimed in claim 13, wherein step e) further comprises storing the private Internet protocol address of the second network device and the converted public Internet protocol address in a mapping table.
